(19) United States
(12) Patent Application Publication
(10) Pub. No.: US 2020/0025438 A1
(43) Pub. Date: Jan. 23, 2020

(54) REFRIGERATION DEVICE

(71) Applicant: BSH HAUSGERAETE GMBH, Muenchen (DE)

(72) Inventors: QINCHAO LIU, NANJING (CN); PING LV, NANJING (CN); CHUAN ZHANG, CHUZHOU (CN)

(21) Appl. No.: 16/508,722

(22) Filed: Jul. 11, 2019

(30) Foreign Application Priority Data
Jul. 18, 2018 (CN) 201810794850.1

(51) Int. Cl. F25D 23/02; E05D 11/06; E05F 1/00; E05D 3/08

(52) U.S. Cl. CPC F25D 23/028; E05D 11/06; E05Y 2900/31; E05D 3/08; F25D 2323/024; E05F 1/00

(57) ABSTRACT

A refrigeration device has a main body, a first door with an opening, and a second door for opening and closing the opening. A first hinge member connects the first door to the main body and a second hinge member that is fixed on the first door including a second door hinge shaft connected to the second door. A first stop portion is fixed on a lower side of the second hinge member and is matched to a first limiting portion of the first hinge member. When the first door rotates to a first preset angle, the first stop portion abuts against the first limiting portion. A stop function is integrated on a hinge of a door body of the refrigeration device, thus reducing a quantity of parts of the refrigeration device and assembly complexity, and improving assembly precision and efficiency of the refrigeration device.

### CROSS-REFERENCE TO RELATED APPLICATION

This application claims the priority, under 35 U.S.C. § 119, of Chinese application CN 201810794850.1, filed Jul. 18, 2018; the prior application is herewith incorporated by reference in its entirety.

### BACKGROUND

### Technical Field

The present invention relates to the field of refrigeration devices, and specifically, to a refrigeration device.

With popularization of refrigeration devices in people's daily life, more and more people start to use the refrigeration devices such as refrigerators to store perishable food such as vegetables and fish and meat.

A refrigerator is used as an example. As one of important components of the refrigerator, a hinge achieves an effect of connecting a door of the refrigerator and a box body. The first step (namely, opening the door of the refrigerator) and the last step (namely, closing the door of the refrigerator) during use of the refrigerator by a user are both closely related to the hinge.

To optimize experience of the user and prevent the door of the refrigerator from being excessively opened, a stop part is generally installed on a door of an existing refrigerator. When the door of the refrigerator is opened to an angle, the door of the refrigerator is limited by using the stop part so that the door of the refrigerator cannot continuously rotate, thus achieving an effect of limiting and stop.

However, an existing hinge applied to the door of the refrigerator is disposed separately from the stop part. A quantity of parts is large, and assembly is complex, which severely affects assembly precision and assembly efficiency during assembly of a refrigeration device.

### BRIEF SUMMARY OF THE INVENTION

An objective of embodiments of the present invention is to provide an improved refrigeration device.

Therefore, an embodiment of the present invention provides a refrigeration device. The refrigeration device includes: a main body; a first door, pivotably disposed on a front side of the main body, the first door having an opening; a second door, pivotably disposed on a front side of the first door to open or close the opening; a first hinge member for pivotably connecting the first door to the main body; and a second hinge member fixed on the first door, the second hinge member including a second door hinge shaft connected to the second door; and the refrigeration device further includes a first stop portion fixed on a lower side of the second hinge member, the first hinge member including a first limiting portion, the first stop portion being matched with the first limiting portion, and when the first door rotates to a first preset angle, the first stop portion being abutted against the first limiting portion.

Compared with the prior art, in the technical solution of this embodiment of the present invention, through mating between the first stop portion and the first limiting portion, continuous rotation of the first door or the first door and the second door after the first preset angle is limited, to prevent damage of a door body caused by an excessively large rotation angle of the first door or the first door and the second door. Further, the first stop portion is fixed on the lower side of the second hinge member, so that the first stop portion and the second hinge member may be integrally prepared in advance. To be specific, a hinge of the door body of the refrigeration device using the technical solution of this embodiment of the present invention is integrated with a stop function, so that a quantity of parts and assembly complexity of the refrigeration device can be effectively reduced, and assembly precision and efficiency of the refrigeration device can be improved.

In one or more embodiments, the second hinge member may further include a first door installation portion fixed on the first door, and the first stop portion is located below the first door installation portion. A disposing position of the first stop portion on the second hinge member is limited, so that effective contact between the first stop portion and the first limiting portion on the first hinge member can be ensured during rotation of the first door (particularly when the first door rotates to the first preset angle), so that the second hinge member stops a rotation angle of the first door or the first door and the second door.

In one or more embodiments, the first stop portion may be integrally formed into the second hinge member. In this way, the quantity of parts and the assembly complexity of the refrigeration device can be better reduced.

In one or more embodiments, the second hinge member may be formed by die casting. In this way, manufacturing precision of the second hinge member integrated with the first stop portion is improved while production efficiency is improved, which is beneficial to improving entire reliability of the refrigeration device.

In one or more embodiments, the first hinge member may include a first connection portion that is fixed on the main body and a first door hinge shaft that is connected to the first door. The first connection portion is beneficial to firmly fixing the first door on the front side of the main body, and mating between the first door hinge shaft and the first door enables the first door to rotate around the first door hinge shaft, to open or close a storage compartment on the main body. The storage compartment has an opening on the front side of the main body. In one or more embodiments, the first stop portion is a stop block, and the first limiting portion is a limiting notch; or the first stop portion is a limiting notch, and the first limiting portion is a stop block. In this way, it may be ensured that mating between the first stop portion and the first limiting portion can limit the rotation angle of the first door or the first door and the second door.

An embodiment of the present invention further provides a refrigeration device. The refrigeration device includes: a main body; a first door, pivotably disposed on a front side of the main body, the first door having an opening; a second door, pivotably disposed on a front side of the first door to open or close the opening; a first hinge member for pivotably connecting the first door to the main body; and a second hinge member fixed on the first door, the second hinge member including a second door hinge shaft connected to the second door, the second hinge member including a second limiting portion, the second door including a second stop portion, the second stop portion being matched with the second limiting portion, and when the second door rotates to a second preset angle, the second stop portion being abutted against the second limiting portion.

Compared with the prior art, in the technical solution of this embodiment of the present invention, through mating between the second stop portion and the second limiting portion, continuous rotation of the second door after the second preset angle is limited, to prevent damage of a door body caused by an excessively large rotation angle of the second door. Further, the second limiting portion is integrated on the second hinge member. To be specific, a hinge of the door body of the refrigeration device using the technical solution of this embodiment of the present invention is integrated with a limiting part. The limiting part can mate with a stop part on the second door to limit a rotation angle of the second door. Through such an integration design, a quantity of parts and assembly complexity of the refrigeration device can be effectively reduced, and assembly precision and efficiency of the refrigeration device can be improved.

In one or more embodiments, the refrigeration device may further include a door opener fixed on the second door, the door opener is coupled to the second hinge shaft, and the second stop portion and the door opener are integrally informed. The second stop portion is integrated to the existing door opener of the second door, so that a quantity of parts of the refrigeration device can be better reduced, which is beneficial to improving assembly precision and efficiency of the refrigeration device.

In one or more embodiments, the door opener may include a second door installation portion fixed on the bottom of the second door, and the second stop portion is connected to the second door installation portion and extends downward. In this way, effective contact between the second stop portion and the second limiting portion on the second hinge member can be ensured during rotation of the second door (particularly when the second door rotates to the second preset angle), so that the second hinge member stops the second door.

In one or more embodiments, the refrigeration device may further include a first stop portion fixed on a lower side of the second hinge member, the first hinge member includes a first limiting portion, the first stop portion is matched with the first limiting portion, and when the first door rotates to a first preset angle, the first stop portion is abutted against the first limiting portion. Through mating between the first stop portion and the first limiting portion, continuous rotation of the first door or the first door and the second door after the first preset angle is limited, to prevent damage of the door body caused by an excessively large rotation angle of the first door or the first door and the second door.

In one or more embodiments, in a width direction of the main body, the first limiting portion may be located on an outer side of the second limiting portion, and the outer side is a side, which is away from an opening and closing side of the first door and/or the second door, of the main body. In this way, the first preset angle may be greater than the second preset angle. On one hand, this is beneficial to fully opening a space on the front side of the main body. On the other hand, this can prevent the second door from being excessively opened and colliding with the first door and damaging the door body.

In one or more embodiments, the first hinge member may include a first connection portion that is fixed on the main body and a first door hinge shaft that is connected to the first door, the second hinge member may further include a columnar portion, and the columnar portion is hinged to the first door hinge shaft, where the columnar portion has a first shaft hole, and the first door hinge shaft extends into the first shaft hole. The columnar portion matched with the first door hinge shaft is disposed on the second hinge member, which is beneficial to accurately positioning the first door and the second door, thereby improving assembly precision of a refrigeration appliance. Further, in the solution of this embodiment, through mating between the first hinge member and the second hinge member, while the main body, the first door, and the second door are hinged to each other, the first door can be effectively prevented from being damaged because of being in direct contact with the first hinge member and increasing maintenance costs. In addition, if strength of a hinge member is higher than that of a top cover or an end cover, in contact with a heat insulation material, of a door of the refrigeration appliance, mating between the second hinge member and the first hinged member that have higher strength is beneficial to avoid a possibility of damage at a hinged position of the door of the refrigeration appliance due to, for example, bearing or collision, thereby increasing reliability of the refrigeration device according to this embodiment. In an embodiment of disposing the second hinge member on the bottom of the first door, stress surfaces may include the first shaft hole and the second hinge member on which the first shaft hole is located, so that a hinge hole on the first door effective that is for hinging to the first hinge member can be effectively prevented from being damaged due to excessive large borne stress.

In one or more embodiments, the second stop portion is a stop block, and the second limiting portion is a limiting notch; or the second stop portion is a limiting notch, and the second limiting portion is a stop block. In this way, it may be ensured that mating between the second stop portion and the second limiting portion can limit a rotation angle of the second door.

In one or more embodiments, the first door and the second door may be respectively provided with a slot body, and the slot bodies of the first door and the second door are spliced, that is connected, to form a space accommodating the second hinge member. In this way, when the second door closes the opening of the first door, the second hinge member may be at least partially hidden, which is beneficial to optimizing entire beauty of the refrigeration device.

The disclosure will become more fully understood from the detailed description given herein below for illustration only. The illustrated embodiments are exemplary only and should not be understood to limit the scope of the disclosure.

### BRIEF DESCRIPTION OF THE SEVERAL VIEWS OF THE DRAWING

FIG. 1 is a schematic partial structural diagram of a refrigeration device according to an embodiment of the present invention;

FIG. 2 is a schematic partial three-dimensional structural diagram of the refrigeration device in FIG. 1;

FIG. 3 is a schematic structural diagram of a first hinge member in FIG. 1;

FIG. 4 is a schematic structural diagram of a second hinge member in FIG. 1;

FIG. 5 is a schematic diagram of combination of the second hinge member in FIG. 1 and a first door and a second door;

FIG. 6 is a schematic diagram of a first door and a second door that are in an open state in FIG. 1;

FIG. 7 is a schematic diagram of combination of hinged parts shown in FIG. 1;

FIG. 8 is a schematic diagram of partial combination of the hinged parts shown in FIG. 7;

FIG. 9 and FIG. 10 are exploded diagrams of the hinged parts shown in FIG. 8 in different visual angles;

FIG. 11 is a schematic diagram of the second door in an open state in FIG. 1;

FIG. 12 is a schematic structural diagram of a door opener in FIG. 1;

FIG. 13 is a schematic structural diagram of another second hinge member according to an embodiment of the present invention;

FIG. 14 is a schematic diagram of combination of the second hinge member shown in FIG. 13 and a first door and a second door;

FIG. 15 is a schematic diagram of combination of the second hinge member shown in FIG. 13 and the first hinge member and the door opener that are shown in FIG. 1;

FIG. 16 is an exploded diagram of FIG. 15; and

FIG. 17 is a sectional diagram of combination of the hinge parts shown in FIG. 15 and a first door and a second door.

### DETAILED DESCRIPTION OF THE INVENTION

Referring now to the figures of the drawing in detail, the following individual elements are illustrated and identified with the following reference numerals: 100: Refrigeration device; 110: Main body; 111: Storage compartment; 120: First door; 121: Opening; 122: Lower door frame member; 123: Receiving hole; 123a: Top wall of the receiving hole; 125: Slot body; 130: Second door; 131: Second door shaft; 132: Door opener; 133: Fixing arm; 134: Second stop portion; 135: Second door installation portion; 136: Screw hole; 140: First hinge member; 141: First connection portion; 142: First door hinge shaft; 144: First limiting portion; 150: Second hinge member; 151: First door installation portion; 152: Second door hinge shaft; 153: Columnar portion; 153a: Upper end of the columnar portion; 154: First shaft hole; 155: Interval slot; 156: Second shaft hole; 157: First stop portion; 158: Second limiting portion; 160: Shaft sleeve; 170: Adjustment member; gap: Gap; α: First preset angle; β: Second preset angle; x: Length direction of the refrigeration device; y: Width direction of the refrigeration device; and z: Height direction of the refrigeration device.

A connection structure of a door body and a box body of an existing refrigeration device is complex, a quantity of related parts is excessively large, and assembly is complex, which severely affects assembly precision and assembly efficiency during assembly of the refrigeration device.

To resolve the foregoing technical problem, an embodiment of the present invention provides a refrigeration device. The refrigeration device includes: a main body; a first door, pivotably disposed on a front side of the main body, the first door having an opening; a second door, pivotably disposed on a front side of the first door to open or close the opening; a first hinge member for pivotably connecting the first door to the main body; and a second hinge member fixed on the first door, the second hinge member including a second door hinge shaft connected to the second door; and the refrigeration device further includes a first stop portion fixed on a lower side of the second hinge member, the first hinge member including a first limiting portion, the first stop portion being matched with the first limiting portion, and when the first door rotates to a first preset angle, the first stop portion being abutted against the first limiting portion.

It is understood by a person skilled in the art that in the technical solution of this embodiment of the present invention, through mating between the first stop portion and the first limiting portion, continuous rotation of the first door or the first door and the second door after the first preset angle is limited, to prevent damage of a door body caused by an excessively large rotation angle of the first door or the first door and the second door.

Further, the first stop portion is fixed on the lower side of the second hinge member, so that the first stop portion and the second hinge member may be integrally prepared in advance. To be specific, a hinge of the door body of the refrigeration device using the technical solution of this embodiment of the present invention is integrated with a stop function, so that a quantity of parts and assembly complexity of the refrigeration device can be effectively reduced, and assembly precision and efficiency of the refrigeration device can be improved.

To make the foregoing objectives, features, and advantages of the present invention more comprehensible, the following describes in detail the specific embodiments of the present invention with reference to the accompanying drawings.

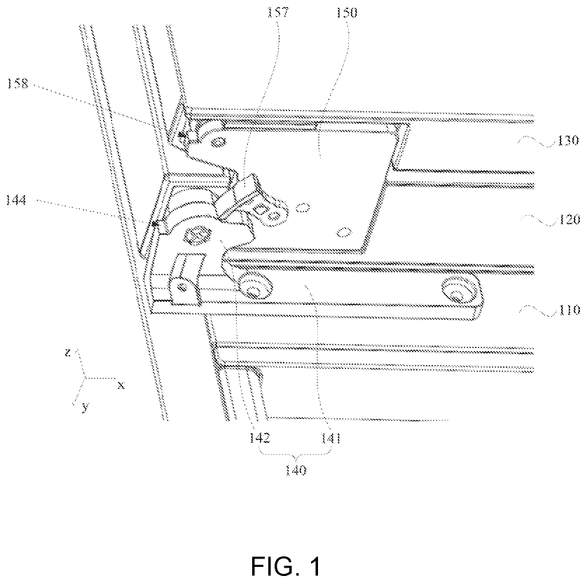

FIG. 1 is a schematic partial structural diagram of a refrigeration device according to an embodiment of the present invention. The refrigeration device may include a refrigerator, a refrigerated cabinet, or the like. FIG. 1 is mainly a schematic diagram of combination at a position at which a door body of the refrigeration device is hinged to a box body.

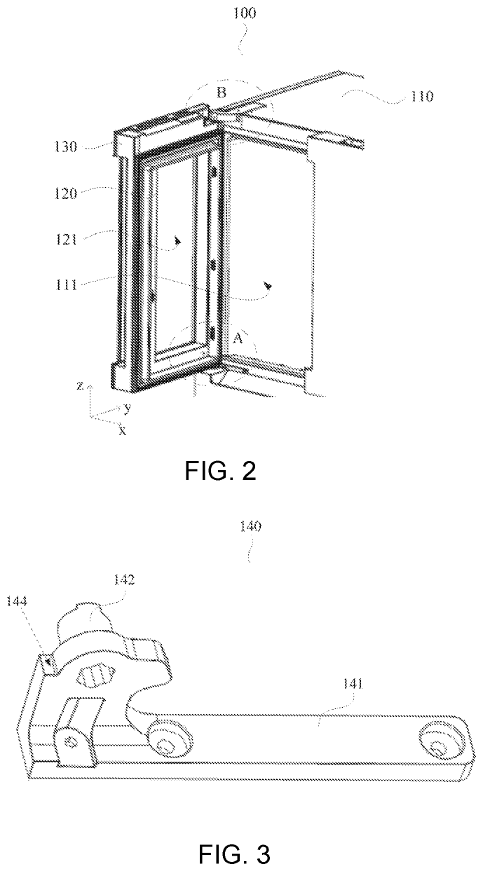

Specifically, in this embodiment, with reference to FIG. 1 and FIG. 2, the refrigeration device 100 may include: a main body 110; a first door 120, the first door 120 being pivotably disposed on a front side of the main body 110, the first door 120 having an opening 121; and a second door 130, the second door 130 being pivotably disposed on a front side of the first door 120 to open or close the opening 121.

For ease of description, in this embodiment, a length direction of the refrigeration device 100 is set to a direction x, a depth direction of the refrigeration device 100 is set to a direction y, and a height direction of the refrigeration device 100 is set to a direction z. Front sides of the main body 110 and the first door 120 may be a side facing a user during actual use. A storage space in the opening 121 or the main body 110 may be opened or closed by opening or closing the first door 120 and/or the second door 130.

A refrigerator is used as an example. Referring to FIG. 2, the main body 110 may be a box body of the refrigerator. The main body 110 includes at least one storage compartment 111. The first door 120 may be configured to uniformly open or close storage compartments 111. Openings 121 on the first door 120 may be in one-to-one correspondence with the storage compartments 111. Second doors 130 may be in one-to-one correspondence with the openings 121. Each second door 130 may be configured to open or close a corresponding opening 121. For example, the first door 120 may be an inner door of the refrigerator, and the second doors 130 may be outer doors of the refrigerator. When only the second doors 130 are opened, only one storage compartment 11 of the main body 110 is exposed (or when the box body includes only one storage compartment 111, only a partial region of the storage compartment 111 may be exposed). When the first door 120 is opened, all the storage compartments 111 of the main body 110 may be exposed (or when the box body includes only one storage compartment 111, all regions of the storage compartment 111 are exposed). In actual application, a person skilled in the art may adjust, according to a requirement, a specific region of the first door 120 that can open or close the main body 110, and a specific shape and size of the opening 121. Details are not described herein again.

More specifically, with reference to FIG. 1 and FIG. 3, the refrigeration device 100 may further include a first hinge member 140. The first hinge member 140 may be configured to pivotably connect the first door 120 to the main body 110.

In one or more embodiments, with reference to FIG. 1 to FIG. 3, the first hinge member 140 may include a first connection portion 141 that is fixed on the main body 110 and a first door hinge shaft 142 that is connected to the first door 120.

Specifically, the first connection portion 141 is beneficial to firmly fixing the first door 120 on the front side of the main body 110, and mating between the first door hinge shaft 142 and the first door 120 enables the first door 120 to rotate around the first door hinge shaft 142, to open or close the storage compartment 111 on the main body 110. The storage compartment 111 has an opening on the front side of the main body 110.

For example, the first connection portion 141 may be fixedly connected to the main body 110 by using a bolt.

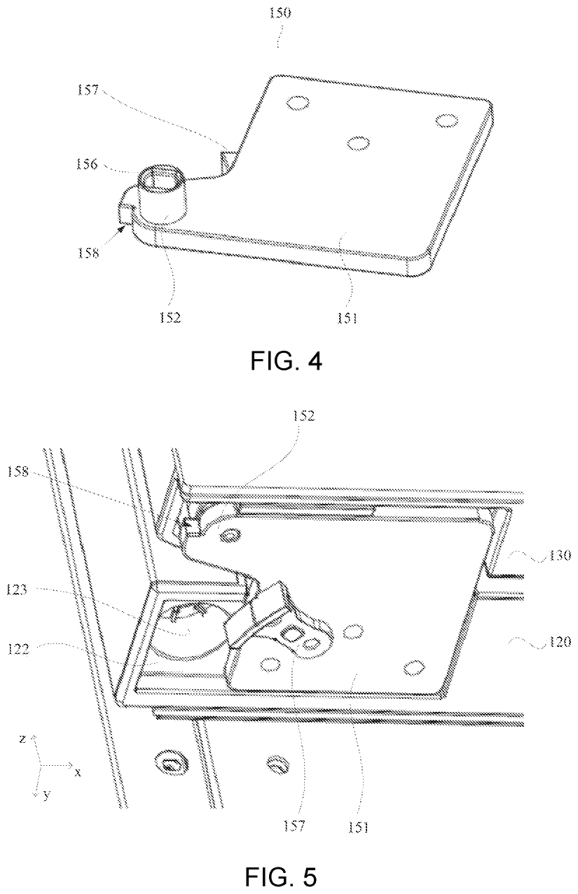

Further, with reference to FIG. 1, FIG. 4, and FIG. 5, the refrigeration device 100 may further include a second hinge member 150 fixed on the first door 120.

In one or more embodiments, the second hinge member 150 may include a second door hinge shaft 152 connected to the second door 130; and the refrigeration device 100 may further include a first stop portion 157 fixed on a lower side of the second hinge member 150. The lower side of the second hinge member 150 is a side, close to the first hinge member 140, of the second hinge member 150 (namely, a side away from the first door 120 and the second door 130 in the direction z).

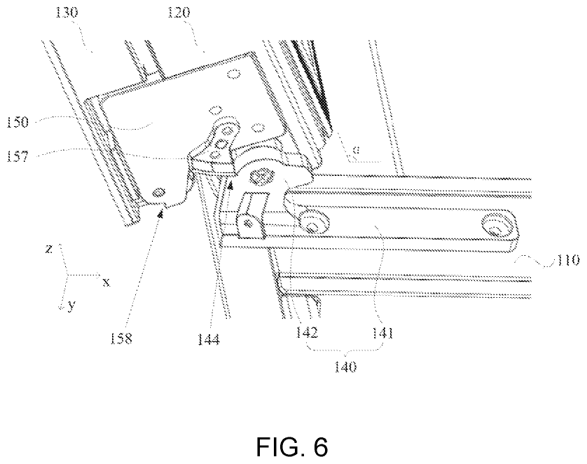

In one or more embodiments, the first hinge member 140 may include a first limiting portion 144, and the first stop portion 157 is matched with the first limiting portion 144. With reference to FIG. 6, and when the first door 120 rotates to a first preset angle α, the first stop portion 157 is abutted against the first limiting portion 144.

It is understood by a person skilled in the art that in the technical solution of this embodiment of the present invention, through mating between the first stop portion 157 and the first limiting portion 144, continuous rotation of the first door 120 (or the first door 120 and the second door 130) after the first preset angle α is limited, to prevent damage of a door body caused by an excessively large rotation angle of the first door 120 (or the first door 120 and the second door 130).

Further, the first stop portion 157 is fixed on the lower side of the second hinge member 150, so that the first stop portion 157 and the second hinge member 150 may be integrally prepared in advance. To be specific, a hinge (for example, the second hinge member 150), for hinging the main body 110 to a door (for example, the first door 120), of the refrigeration device 100 using the technical solution of this embodiment of the present invention is integrated with a stop function, so that a quantity of parts and assembly complexity of the refrigeration device 100 can be effectively reduced, and assembly precision and efficiency of the refrigeration device can be improved.

For example, the first stop portion 157 may be adhered to the second hinge member 150 in advance (for example, when the second hinge member 150 is generated).

For another example, the first stop portion 157 may further be connected to the second hinge member 150 in interference fit, to prevent the first stop portion 157 from loosing and affecting a stop effect.

In one or more embodiments, with reference to FIG. 1 to FIG. 5, the second door 130 may rotate around the second door hinge shaft 152, to open or close the opening 121 on the front side of the first door 120.

In one or more embodiments, still referring to FIG. 1, FIG. 4, and FIG. 5, the second hinge member 150 may further include a first door installation portion 151 fixed on the first door 120, and the first stop portion 157 is located below the first door installation portion 151.

It is understood by a person skilled in the art that a disposing position of the first stop portion 157 on the second hinge member 150 is limited, so that effective contact between the first stop portion 157 and the first limiting portion 144 on the first hinge member 140 can be ensured during rotation of the first door 120 (particularly when the first door 120 rotates to the first preset angle α shown in FIG. 6), so that the second hinge member 150 stops a rotation angle of the first door 120 (or the first door 120 and the second door 130).

In one or more embodiments, through a through hole provided on the first door installation portion 151, the second hinge member 150 may be fixed on the first door 120 by means of bolt connection. Further, through mating between the second door hinge shaft 152 and the second door 130, the second door 130 can rotate around the second door hinge shaft 152.

In one or more embodiments, the first door 120 may include a lower door frame member 122. The lower door frame member 122 may have a receiving hole 123 recessed toward the interior of the first door 120. The first door hinge shaft 142 may extend into the receiving hole 123, so that the first door 120 rotates around the first door hinge shaft 142.

In one or more embodiments, referring to FIG. 1 and FIG. 2 (FIG. 1 may be considered as a partial enlarged diagram of a region A in FIG. 2) the second hinge member 150 may be fixed on the bottom of the first door 120 (for example, a position of the region A in FIG. 2) and/or the top of the first door 120 (for example, a position of a region B in FIG. 2). This is beneficial to positioning of the first door 120 and the second door 130 above and/or below.

In one or more embodiments, referring to FIG. 1, the first door installation portion 151 may be board-shaped and connected to a bottom surface of the first door 120. This is beneficial to ensuring an aesthetic appearance of the refrigeration device 100 while enlarging a stress surface of the second hinge member 150.

In one or more embodiments, the first stop portion 157 may be integrally formed into the second hinge member 150, thus better reducing the quantity of parts and the assembly complexity of the refrigeration device 100.

In a preferable example, the second hinge member 150 may be formed by die casting, thus improving manufacturing precision of the second hinge member 150 integrated with the first stop portion 157 while improving production efficiency, and being beneficial to improving entire reliability of the refrigeration device 100.

In one or more embodiments, referring to FIG. 1, FIG. 3, and FIG. 6, the first stop portion 157 may be a stop block, and the first limiting portion 144 may be a limiting notch.

Alternatively, the first stop portion 157 may be a limiting notch, and the first limiting portion 144 may be a stop block.

In this way, it may be ensured that mating between the first stop portion 157 and the first limiting portion 144 can limit the rotation angle of the first door 120 (or the first door 120 and the second door 130).

In one or more embodiments, the second door 130 and the first door 120 are pivotably disposed on the front side of the main body 110 by using hinged parts. The hinged parts may include the first hinge member 140, the second hinge member 150, and the door opener 132 fixed on the second door 130. Through mating between the first hinge member 140, the second hinge member 150, and the door opener 132, an opening and closing function of the first door 120 and/or the second door 130 is implemented.

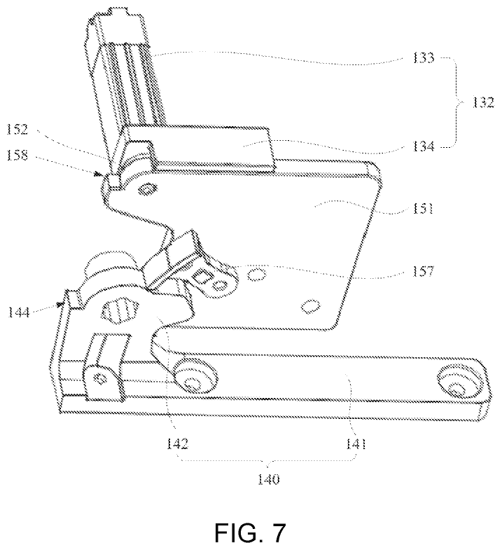

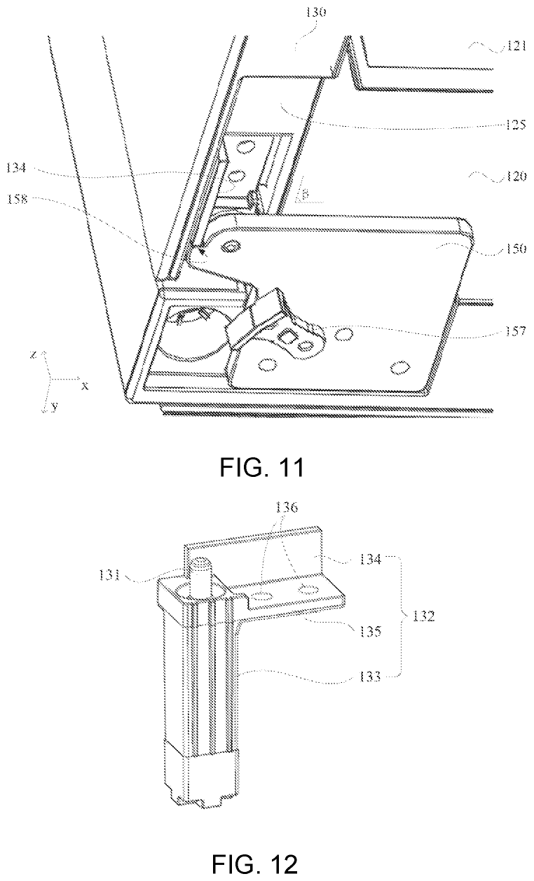

In one or more embodiments, referring to FIG. 1, and FIG. 7 to FIG. 10, the refrigeration device 100 in this embodiment may include: a main body 110; a first door 120, pivotably disposed on a front side of the main body 110, the first door 120 having an opening 121; a second door 130, pivotably disposed on a front side of the first door 120 to open or close the opening 121; a first hinge member 140 for pivotably connecting the first door 120 to the main body 110; and a second hinge member 150 fixed on the first door 120, the second hinge member including a second door hinge shaft 152 connected to the second door 130, the second hinge member 150 including a second limiting portion 158, the second door 130 including a second stop portion 134, and the second stop portion 134 being matched with the second limiting portion 158. With reference to FIG. 11, when the second door 130 rotates to a second preset angle β, the second stop portion 134 is abutted against the second limiting portion 158.

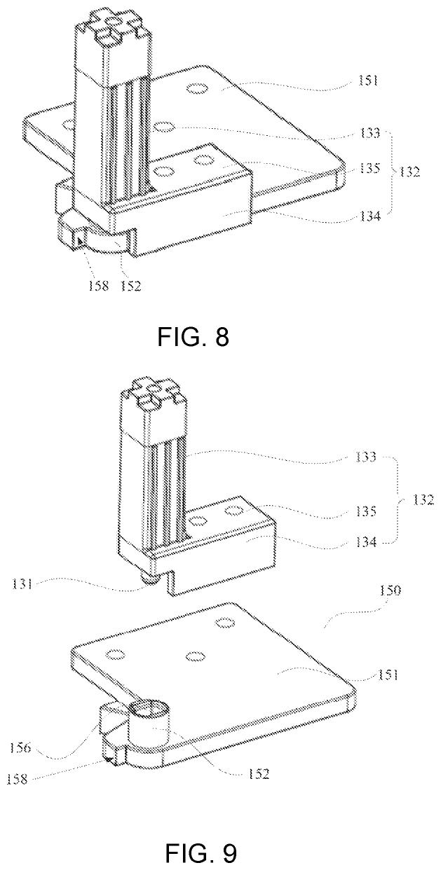

To more clearly present partial details of hinge parts, FIG. 8 to FIG. 11 omit the first hinge member 140 in FIG. 7.

It is understood by a person skilled in the art that in the technical solution of this embodiment of the present invention, through mating between the second stop portion 134 and the second limiting portion 158, continuous rotation of the second door 130 after a second preset angle β is limited, to prevent damage of the door body caused by an excessive large rotation angle of the second door 130.

Further, the second limiting portion 158 is integrated on the second hinge member 150. To be specific, a hinge of the door body of the refrigeration device using the technical solution of this embodiment of the present invention is integrated with a limiting part (namely, the second limiting portion 158). The limiting part can mate with a stop part (namely, the second stop portion 134) on the second door 130 to limit a rotation angle of the second door 130. Through such an integration design, a quantity of parts and assembly complexity of the refrigeration device 100 can be effectively reduced, and assembly precision and efficiency of the refrigeration device 100 can be improved.

In one or more embodiments, the refrigeration device 100 may further include a door opener 132 fixed on the second door 130, the door opener 132 is coupled to the second door hinge shaft 152, and the second stop portion 134 and the door opener 132 are integrally informed. The second stop portion 134 is integrated to the existing door opener 132 of the second door 130, so that a quantity of parts of the refrigeration device 100 can be better reduced, which is beneficial to improving assembly precision and efficiency of the refrigeration device 100.

In one or more embodiments, referring to FIG. 7 to FIG. 10 and FIG. 12, the door opener 132 may include a second door installation portion 135 fixed on the bottom of the second door 130, and the second stop portion 134 is connected to the second door installation portion 135 and extends downward (namely, along a reverse direction of the direction z, namely, a direction away from the door opener 132). In this way, effective contact between the second stop portion 134 and the second limiting portion 158 on the second hinge member 150 can be ensured during rotation of the second door 130 (particularly when the second door 130 rotates to the second preset angle β), so that the second hinge member 150 stops the second door 130.

In one or more embodiments, the second door installation portion 135 may include a fixing arm 133. A length direction of the fixing arm 133 is parallel to the direction z. The fixing arm 133 extends into the second door 130, so that connection between the second door 130 and the main body 110 is more stable.

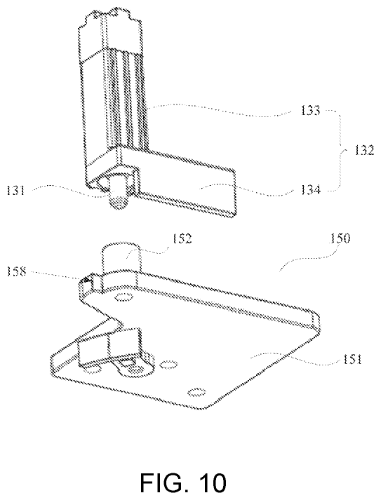

In one or more embodiments, referring to FIG. 4, FIG. 9, and FIG. 10, the second door hinged shaft 152 may include a second shaft hole 156. The second door 130 may include a second door shaft 131. The second door shaft 131 is rotatably located in the second shaft hole 156. In this way, the second door 130 can rotate around the second door shaft 131, to open or close the opening 121.

In one or more embodiments, the second door shaft 131 may be coupled to the door opener 132, to reduce a quantity of parts, facilitate installation, and improve integration.

In one or more embodiments, still referring to FIG. 12, the second door installation portion 135 may be provided with a screw hole 136, to fix the door opener 132 in the second door 130 by means of screw connection.

In one or more embodiments, referring to FIG. 9 to FIG. 12, the second stop portion 134 may be a stop plate (or a stop block), and the second limiting portion 158 may be a limiting notch.

Alternatively, the second stop portion 134 may be a limiting notch, and the second limiting portion 158 may be a stop block (or a stop plate).

In this way, it may be ensured that mating between the second stop portion 134 and the second limiting portion 158 can limit the rotation angle of the second door 130.

In one or more embodiments, the refrigeration device 100 may further include a first stop portion 157 fixed on a lower side of the second hinge member 150, the first hinge member 140 may include a first limiting portion 144, the first stop portion 157 is matched with the first limiting portion 144, and when the first door 120 rotates to a first preset angle α, the first stop portion 157 is abutted against the first limiting portion 144. Through mating between the first stop portion 157 and the first limiting portion 144, continuous rotation of the first door 120 (or the first door 120 and the second door 130) after the first preset angle α is limited, to prevent damage of the door body caused by the excessively large rotation angle of the first door 120 (or the first door 120 and the second door 130).

In one or more embodiments, still referring to FIG. 1, in a width direction of the main body 110 (namely, the direction x), the first limiting portion 144 may be located on an outer side of the second limiting portion 158, and the outer side is a side, which is away from an opening and closing side of the first door 120 and/or the second door 130, of the main body 110. To be specific, along the direction x from an angle shown in the figure, the second limiting portion 158 is located on a right side of the first limiting portion 144.

It is understood by a person skilled in the art that based on the design of this embodiment, the first preset angle α may be greater than the second preset angle β. For example, the first preset angle α may be greater than 90°, and the second preset angle β is 90°. In this way, on one hand, this is beneficial to fully opening a space (namely, the storage compartment 111) on the front side of the main body 110. On the other hand, this can prevent the second door 130 from being excessively opened and colliding with the first door 120 and damaging the door body.

Preferably, a value range of the first preset angle α may be between 90° and 180°, and the second preset angle β is not greater than 90°.

In one or more embodiments, still referring to FIG. 1, FIG. 5, and FIG. 11, the first door 120 and the second door 130 may be respectively provided with a slot body 125, and the slot bodies 125 of the first door 120 and the second door 130 are spliced, that is connected, to form a space accommodating the second hinge member 150. In this way, when the second door 130 closes the opening 121 of the first door 120, the second hinge member 150 may be at least partially hidden, thus being beneficial to optimizing entire beauty of the refrigeration device 100. To be specific, a plane formed by the second hinge member 150 in the direction x and the direction y and a lower surface of the first door 120 and the second door 130 are in a same plane, thus implementing a hidden design of the second hinge member 150, and being beneficial to optimizing entire beauty of the refrigeration device.

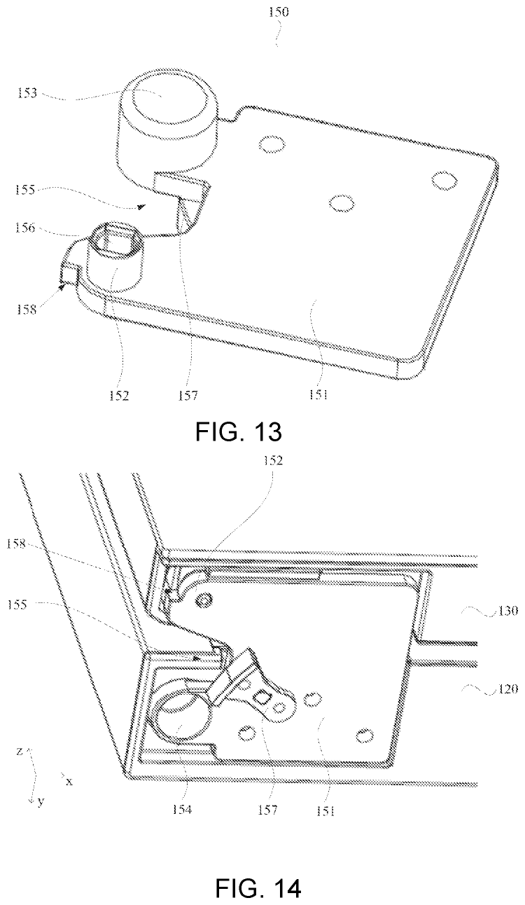

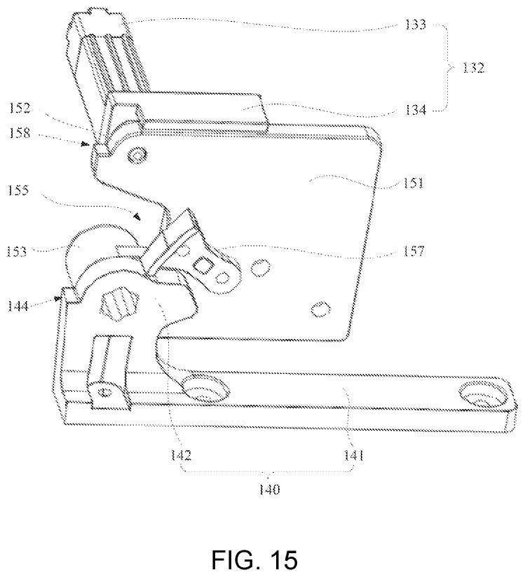

In one or more alternative embodiments, referring to FIG. 13 to FIG. 16, the second hinge member 150 may further include a columnar portion 153, and the columnar portion 153 is hinged to the first door hinge shaft 142, where the columnar portion 153 has a first shaft hole 154, and the first door hinge shaft 142 extends into the first shaft hole 154.

It is understood by a person skilled in the art that in the solution of this alternative embodiment, through mating between the first hinge member 140 and the second hinge member 150, while the main body 110, the first door 120, and the second door 130 are hinged to each other, the first door 120 can be effectively prevented from being damaged because of being in direct contact with the first hinge member 140 and increasing maintenance costs. In addition, if strength of a hinge member is higher than that of a door body of the refrigeration device 100 and that of a top cover or an end cover, in contact with a heat insulation material, of the door body, mating between the second hinge member 150 and the first door hinge shaft 142 that have higher strength is beneficial to avoiding a possibility of damage at a hinged position of the door body of the refrigeration device 100 due to, for example, bearing or collision, thereby increasing reliability of the refrigeration device 100 according to this embodiment. Further, the columnar portion 153 matched with the first door hinge shaft 142 is disposed on the second hinge member 150, which is beneficial to precisely positioning the first door 120 and the second door 130, thereby improving assembly precision of the refrigeration device 100.

Further, the first shaft hole 154 may be located in the first door 120, and the first door hinge shaft 142 may extend into the columnar portion 153. This is beneficial to precisely positioning the first door 120. Further, in an embodiment of disposing the second hinge member 150 on the bottom of the first door 120, stress surfaces may include the first shaft hole 154 and the second hinge member 150 on which the first shaft hole 154 is located, so that a hinge hole (namely, a part on the first door 120 that is for accommodating the columnar portion 153) on the first door 120 that is for hinging to the first hinge member 140 can be effectively prevented from being damaged due to excessive large borne stress.

Preferably, the first shaft hole 154 may be a blind hole, to centralize stress surfaces on the first shaft hole 154 and the second hinge member 150 on which the first shaft hole 154 is located, thus effectively preventing the first door 120 from being damaged because of being in direct contact with the first hinge member 140.

To be specific, based on the solution of this alternative embodiment, the first door 120 may be supported on the first hinge member 140 via the second hinge member 150. It is understood by a person skilled in the art that based on the design of this embodiment, when the first hinge member 140 supports the first door 120, a stress surface is the second hinge member 150, so that the door frame of the first door 120 can be effectively prevented from being damaged because of being in direct contact with the first hinge member 140.

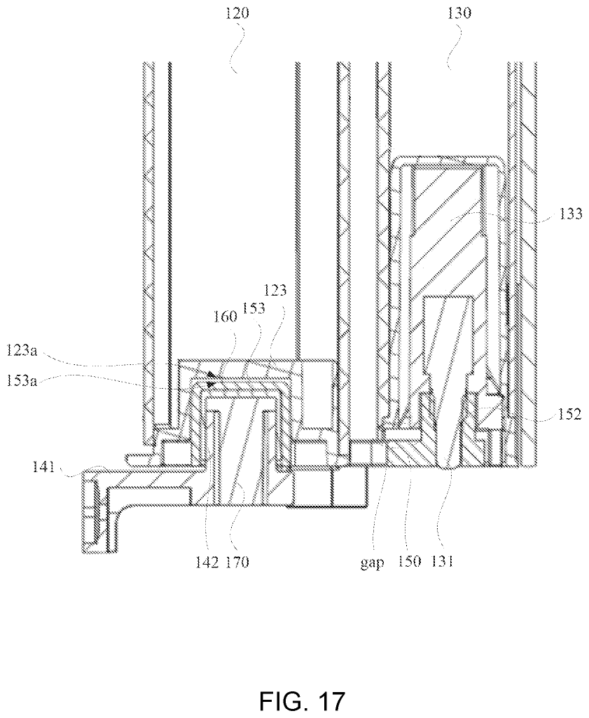

Further, referring to FIG. 5, FIG. 13, and FIG. 17, the first door 120 may include a lower door frame member 122. The lower door frame member 122 may have a receiving hole 123 recessed toward the interior of the first door 120. The columnar portion 153 may extend into the receiving hole 123. There is an interval between an upper end 153a of the columnar portion 153 and a top wall 123a of the receiving hole 123. This is beneficial to preventing an end wall of the receiving hole 123 from bearing stress and being damaged because of being in direct contact with an end portion of the columnar portion 153.

For example, sizes of the columnar portion 153 and the receiving hole 123 in an axial direction (parallel to the direction z) may be adjusted to form the interval between the upper end 153a of the columnar portion 153 and the top wall 123a of the receiving hole 123.

Further, the columnar portion 153 and the first door installation portion 151 may be integrally informed. This is beneficial to positioning the first door 120 and the second door 130, and is beneficial to improving entire firmness of the second hinge member 150, thus preventing the second hinge member 150 from compressing and deforming and even breaking when the first hinge member 140 supports the first door 120 via the second hinge member 150.

Specifically, the second hinge member 150 is fixed on the bottom of the first door 120. The first hinge member 140 is matched with the second hinge member 150 when supporting the first door 120, thus preventing the first hinge member 140 from being directly abutted against a plastic door frame of the first door 120, thus being beneficial to preventing damage of a door frame member of the first door 120.

The columnar portion 153 and the first door installation portion 151 may be integrally informed, for example, may be integrally formed through casting.

Further, the second door hinge shaft 152 may be integrally formed through casting with the columnar portion 153 and the first door installation portion 151.

Further, still referring to FIG. 13 to FIG. 16, the second hinge member 150 may further include an interval slot 155 between the second door hinged shaft 152 and the columnar portion 153, and the interval slot 155 may be at least partially located between the first door 120 and the second door 130. This is beneficial to precisely positioning a distance between the first door 120 and the second door 130, and prevents a size chain from being excessively long caused by assembly of a plurality parts.

For example, a side, which faces toward the first door 120, of the interval slot 155 may be open, to make it convenient to remove and assemble. For example, an extension direction of the interval slot 155 may be parallel to a length direction of the first door 120 (to be specific, parallel to the direction x), and a direction of an opening of the interval slot 155 may be the same as a direction of opening the first door 120 and/or the second door 130.

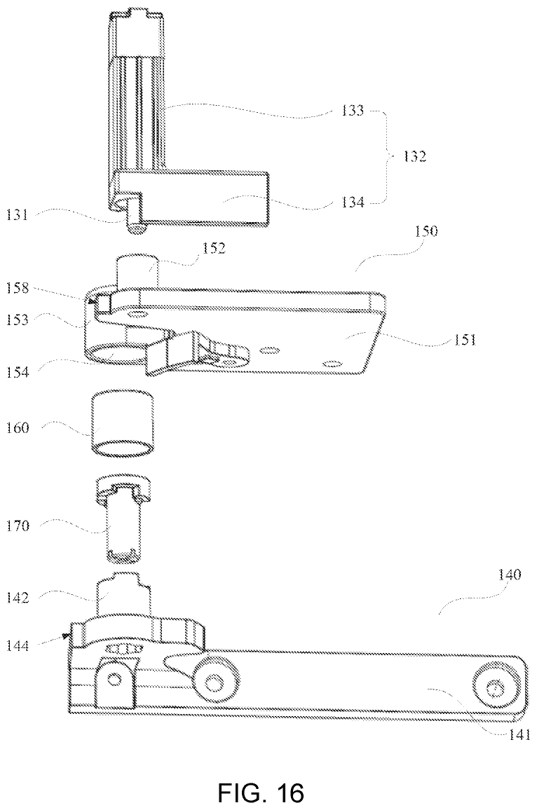

Further, referring to FIG. 16, the refrigeration device 100 may further include a shaft sleeve 160 located within the first shaft hole 154. This is beneficial to preventing the first door hinged shaft 142 from rotating relative to the columnar portion 153 and wearing or making abnormal sound.

Further, still referring to FIG. 16, the refrigeration device 100 may further include an adjustment member 170 for adjusting the height of the first door 120 relative to the main body 110. With reference to FIG. 17, the adjustment member 170 is connected to the first door hinged shaft 142. This facilitates flexible adjustment of the height of the first door 120 relative to the main body 110, and is conducive to precisely positioning a position of the first door 120 relative to the main body 110 and beneficial to assembly.

Preferably, the adjustment member 170 may be located in the shaft sleeve 160.

Further, with reference to FIG. 16 and FIG. 17, a plurality of steps may be respectively disposed relatively on the adjustment member 170 and the first door hinge shaft 142. Through pairing of steps on butting end surfaces of the adjustment member 170 and the first door hinge shaft 142, a distance between the shaft sleeve 160 and the first door hinge shaft 142 can be adjusted in the direction z, thus adjusting a height position of the first door 120 relative to the main body 110 in the direction z.

For example, through pairing of the steps on the butting end surfaces of the adjustment member 170 and the first door hinge shaft 142, the second hinge member 150 and the first door 120 may be raised along the direction z (or lowered along the reverse direction of the direction z), to ensure that the first door 120 can effectively close the storage compartment 111 of the main body 110.

In a non-limiting embodiment, still referring to FIG. 17, there is a gap between top surfaces and/or bottom surfaces of the second hinge member 150 and the second door 130, to be beneficial to rotation of the second door 130 around the second door shaft 131.

Further, the second hinge member 150 is connected to a top surface and/or a bottom surface of the first door 120, to further disperse stress on the receiving hole 123 to the first door 120 via the second hinge member 150, to better prevent the first door 120 (for example, the plastic door frame of the first door 120) from being damaged.

The present invention is disclosed as above, but the present invention is not limited thereto. Any person skilled in the art may vary or modify the present invention, without departing from the spirit or scope of the present invention. Therefore, the protection scope of the present invention is defined by the claims.

1. A refrigeration device, comprising:
a main body;
a first door pivotably mounted on a front side of the main body, the first door having an opening;
a second door, pivotably mounted on a front side of the first door and configured to selectively open and close the opening;
a first hinge member for pivotably connecting the first door to the main body;
a second hinge member fixed to the first door, the second hinge member including a second door hinge shaft connected to the second door; and
a first stop portion fixed on a lower side of the second hinge member, said first hinge member having a first limiting portion, the first stop portion being matched with the first limiting portion, and wherein, when the first door rotates to a first preset angle, the first stop portion abuts against the first limiting portion.

2. The refrigeration device according to claim 1, wherein the second hinge member further comprises a first door installation portion fixed on the first door, and the first stop portion is located below the first door installation portion.

3. The refrigeration device according to claim 1, wherein the first stop portion is integrally formed on the second hinge member.

4. The refrigeration device according to claim 3, wherein the second hinge member is formed by die casting.

5. The refrigeration device according to claim 1, wherein the first hinge member comprises a first connection portion that is fixed to the main body and a first door hinge shaft that is connected to the first door.

6. The refrigeration device according to claim 1, wherein the first stop portion is a stop block, and the first limiting portion is a limiting notch; or the first stop portion is a limiting notch, and the first limiting portion is a stop block.

7. A refrigeration device, comprising:
a main body;
a first door pivotably mounted on a front side of the main body, the first door having an opening;
a second door pivotably mounted on a front side of the first door to open or close the opening;
a first hinge member for pivotably connecting the first door to the main body; and
a second hinge member fixed to the first door, the second hinge member including a second door hinge shaft connected to the second door, the second hinge member having a second limiting portion, the second door having a second stop portion, the second stop portion being matched with the second limiting portion, and wherein, when the second door rotates to a second preset angle, the second stop portion abuts against the second limiting portion.

8. The refrigeration device according to claim 7, wherein the refrigeration device further comprises a door opener fixed on the second door, the door opener is coupled to the second hinge shaft, and the second stop portion and the door opener are integrally informed.

9. The refrigeration device according to claim 8, wherein the door opener comprises a second door installation portion fixed on the bottom of the second door, and the second stop portion is connected to the second door installation portion and extends downward.

10. The refrigeration device according to claim 7, wherein the refrigeration device further comprises a first stop portion fixed on a lower side of the second hinge member, the first hinge member comprises a first limiting portion, the first stop portion is matched with the first limiting portion, and when the first door rotates to a first preset angle, the first stop portion is abutted against the first limiting portion.

11. The refrigeration device according to claim 10, wherein in a width direction of the main body, the first limiting portion is located on an outer side of the second limiting portion, and the outer side is a side, which is away from an opening and closing side of the first door and/or the second door, of the main body.

12. The refrigeration device according to claim 7, wherein the first hinge member comprises a first connection portion that is fixed on the main body and a first door hinge shaft that is connected to the first door, the second hinge member further comprises a columnar portion, and the columnar portion is hinged to the first door hinge shaft, wherein the columnar portion has a first shaft hole, and the first door hinge shaft extends into the first shaft hole.

13. The refrigeration device according to claim 7, wherein the second stop portion is a stop block, and the second limiting portion is a limiting notch; or the second stop portion is a limiting notch, and the second limiting portion is a stop block.

14. The refrigeration device according to claim 7, wherein the first door and the second door are respectively provided with a slot body, and the slot bodies of the first door and the second door are spliced to form a space accommodating the second hinge member.
